(19) United States
(12) Patent Application Publication
(10) Pub. No.: US 2008/0273507 A1
(43) Pub. Date: Nov. 6, 2008

(54) Direct station-to-station link between wireless network devices

(76) Inventor: Suman Sharma, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/799,980

(22) Filed: May 3, 2007

(51) Int. Cl. H04Q 7/24

(52) U.S. Cl. 370/338

(57) ABSTRACT

Some embodiments of the invention may establish a direct station-to-station-link (STSL) between client devices in an IEEE 802.11 network by using the payload portion of communicated frames to set up the STSL. Legacy access points may be able to handle this procedure without having to be modified, as they would to implement a Direct Link Setup (DLS) approach.

### BACKGROUND

Historically, when following standards established by the Institute of Electrical and Electronic Engineers standard 802.11 (IEEE 802.11) for wireless local area network (WLAN) protocols, client nodes such as mobile devices communicate directly only with a centralized access point (AP). The AP can then forward any data traffic that is ultimately destined for another client device. More recent WLAN standards have permitted direct client-to-client links between two mobile devices being serviced by the same AP (provided the two mobile devices are within range of each other) by using the AP to help set up the direct link through a procedure called Direct Link Setup (DLS). At the time of this writing, DLS was defined in IEEE 802.11-2007. Once the direct link has been set up in this manner, the two client devices may communicate directly with each other for a period of time without using the AP as an intermediary. But using DLS requires that existing AP's be modified to perform this setup procedure. Modifying every existing AP that might be required to participate in this procedure would be very expensive.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a WLAN network with station-to-station link capability, according to an embodiment of the invention.

FIG. 2 shows a flow diagram of a communications exchange pertaining to an STSL connection, according to an embodiment of the invention.

FIG. 3 shows a diagram of the format of a WLAN frame, and the contents of the payload section of that from that enable the STSL connection.

FIGS. 4A, 4B, and 4C show three specific types of STSL payloads, according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

Various embodiments of the invention may use the payload section of a conventional wireless local area network (WLAN) frame to establish a direct link between two client devices in that network. By using a standard format and embedding the necessary information in the flexible payload field, the direct link procedure may be implemented without having to modify existing access points.

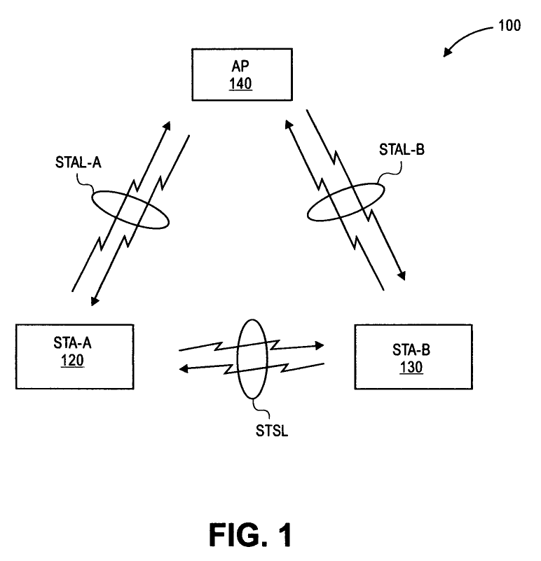

FIG. 1 shows a diagram of a WLAN network with station-to-station link (STSL) capability, according to an embodiment of the invention. Within the context of this document, the term STSL will be used to indicate a wireless communications link directly between two devices, neither of which is an access point, but both of which are communicatively associated with the same access point. This WLAN network may comply with formats, protocols, and restrictions outlined in standard IEEE 802.11-2007, published in 2007 by the Institute of Electrical and Electronic Engineers. In the illustrated network 100, a wireless client device 120 may establish a wireless communications link with an access point (AP) 140. Another wireless client device 130 may similarly establish a wireless communications link with the same AP 140. Other wireless client devices may also be present in the network, but for simplicity of illustration they are not shown. Each wireless client device is labeled as a STA, to be consistent with industry terminology, with device 120 labeled as STA-A and device 130 labeled as STA-B. The wireless link between STA-A and the AP is labeled STAL-A and the wireless link between STA-B and the AP is labeled STAL-B. Normally, STA-A might communicate directly only with the AP, and STA-B might also communicate directly only with the AP, with any communications between STA-A and STA-B being routed through the AP, using conventional techniques. However, by using the techniques described herein, STA-A and STA-B may also establish a direct wireless link between themselves, with this station-to-station link labeled as STSL, so that communications between STA-A and STA-B do not have to be routed through the AP.

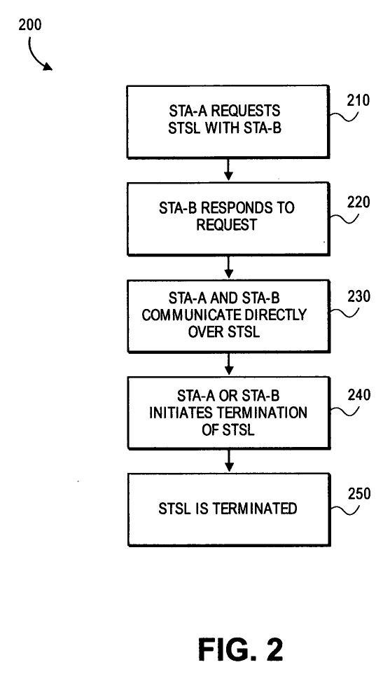

FIG. 2 shows a flow diagram of a communications exchange pertaining to an STSL connection, according to an embodiment of the invention. In the illustrated flow diagram 200, client devices designated STA-A and STA-B (see FIG. 1) may create, use, and terminate an STSL connection between themselves. At 210, STA-A may attempt to originate the STSL connection with STA-B by transmitting a frame destined for STA-B requesting such a connection. This frame is routed through the AP that both STA-A and STA-B are associated with.

At 220, STA-B may respond to this request by transmitting a flame destined for STA-A, indicating STA-B's acceptance or rejection of the request. This response may also be routed through the commonly shared AP described for 210. If STA-B rejects the request (not shown), the communications sequence may end, or STA-A may try again, possibly using different criteria for the connection. Assuming STA-B accepts the request, STA-A and STA-B may begin communicating directly with each other at 230, using the STSL connection they have established at 210 and 220. In some embodiments, STA-A and STA-B may begin communicating directly over the STSL once STA-A has received the acceptance from STA-B. In other embodiments, STA-A and STA-B may need to negotiate further details of the STSL connection, through the AP(s), before starting direct communications with each other. Although STA-A and STA-B are able to communicate directly with each other once the STSL connection has been established, in some embodiments they may also send some frames to each other indirectly through the AP while the STSL connection is still established.

If STA-A wishes to terminate the STSL connection at some point, it may do so at 240 by sending a termination frame, which may sometimes be called a tear-down frame, to STA-B, resulting in the STSL being ended at 250. Alternately, STA-B may terminate the STSL connection by sending the termination frame to STA-A, with the same results. The STSL connection may also be terminated based on other things, such as but not limited to: 1) a pre-determined period of time after the connection was established, 2) one device does not receive any communications from the other device over the STSL connection for a pre-determined period of time, 3) the AP or some other device directs termination of the STSL connection, 4) the quality of communication between the two devices deteriorates below a certain threshold (signal too weak, too much interference, error rate is too high, etc.), 5) detection of radar signals on the channel, 6) etc.

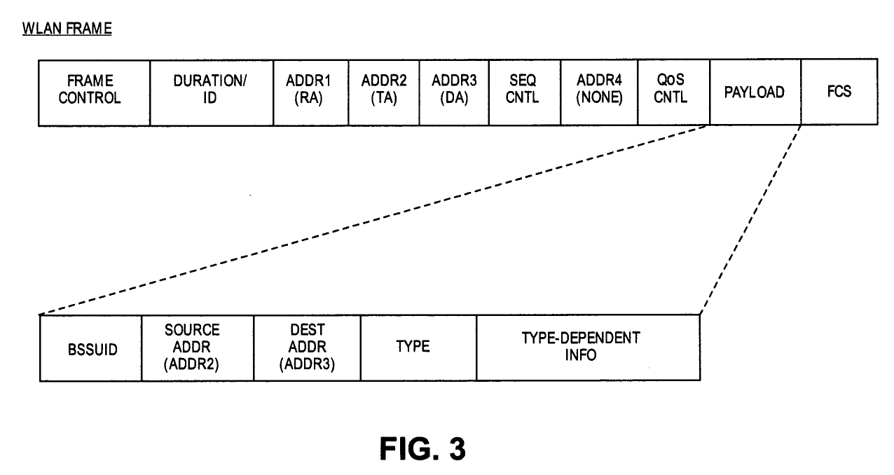

FIG. 3 shows a diagram of the format of a WLAN frame, and the contents of the payload section of that frame that pertain to the STSL connection. When STA-A wishes to establish an STSL connection with STA-B, it can send a frame indicating such to STA-B indirectly, through the AP, using a standard WLAN format. A standard format is shown at the top of FIG. 2, while the unique use of the payload section is shown at the bottom of FIG. 2. The payload section is sometimes also called the frame body, and may contain the deliverable contents of the frame. The remainder of the frame is generally used to deliver the frame from one node to another, regardless of the contents of the payload section. Although a specific WLAN frame format is shown, other formats may also be used without diverging from the unique aspects of various embodiments of the invention.

The WLAN format may be found in the aforementioned standard IEEE 802.11-2007, but is repeated at the top of FIG. 3 for convenience. In this format, the flame begins with a Frame Control section, which specifies various parameters of the frame, followed by a Duration/ID section, which among other things indicates the length of the frame. This may be followed by three addresses. In the illustrated embodiment, the first address (ADDR1) is the Receive address, i.e., the address of the node that is to directly receive this frame. The second address (ADDR2) is the Transmit address, i.e., the address of the device that is transmitting this frame. The third address (ADDR3) is the Destination address, i.e., the address of the device that is to ultimately receive the payload of this frame, regardless of how many other devices the frame has to be forwarded through. In the case of STA-A sending a frame to the AP that is ultimately destined for STA-B, the Transmit address would indicate STA-A (and would also be the source address, i.e., the address of the device that initiates this frame), the Receive address would indicate the AP, and the Destination address would indicate STA-B.

These three addresses may be followed by a Sequence Control section, to help in reconstructing a string of multiple frames that might be routed through different nodes, some of which might have to be retransmitted, and/or might be received out of order by the destination device. A fourth address may optionally follow, but may be unused in this particular implementation. QoS CNTL may be used to indicate that the protocols for Quality of Service communications are being used. This is then followed by the payload section, and then a Frame Checksum section FCS which may be used to detect errors in the received frame.

An expanded view of the payload section is shown in the bottom part of FIG. 3. The format of this payload section may be used to indicate this is a frame that pertains to an STSL connection between two client devices in the network. Although various fields within the payload are shown arranged in a particular order, other embodiments may use a different arrangement and/or somewhat different fields than those shown. In the illustrated embodiment, a basic service set unique identifier (BSSUID) contains the set of parameters necessary to identify the BSS uniquely. In some embodiments the BSSUID field will contain the BSS ID, the applicable regulatory class, and the channel number. A source address, labeled SOURCE ADDR, indicates the device that created this payload and/or is initiating this frame (this may be a duplicate of ADDR2 shown earlier in the frame). A destination address, labeled DEST ADDR, indicates the device that is the intended recipient of the information in the payload (this may be a duplicate of ADDR3 shown earlier in the frame). These are the two devices that are involved in the STSL connection (or potential connection).

These addresses may then be followed by the TYPE field, to indicate which of several types of STSL communication is represented in this payload. For example, TYPE may indicate things such as, but not limited to: 1) a request to establish an STSL between two client devices, 2) a response to that request, either accepting or rejecting the request, 3) a notice that the STSL is being terminated, 4) etc. One or more fields, collectively labeled TYPE-DEPENDENT INFO, may follow the TYPE field. The nature and format of these fields may be dependent on what was specified in the TYPE field.

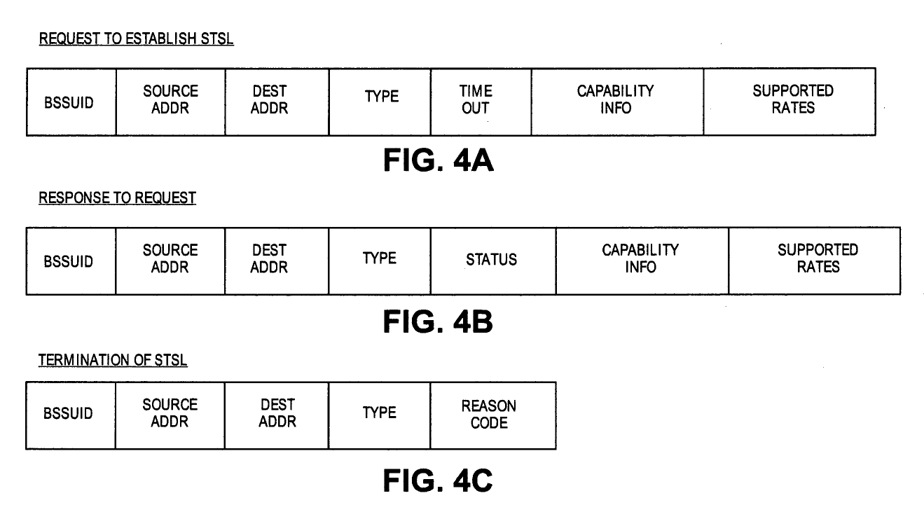

FIGS. 4A, 4B, and 4C show three specific types of STSL payloads, according to embodiments of the invention. The first four fields (BSSUID, SOURCE ADDR, DEST ADDR, and TYPE) of each of these are as previously described in FIG. 3, while the remaining sub-fields expand on the TYPE-DEPENDENT INFO of FIG. 3.

FIG. 4A shows the format of a request to establish an STSL, transmitted by a device wishing originate such a link (e.g., STA-A in FIG. 2). SOURCE ADDR may indicate the identity of the requester, while DEST ADDR may indicate the identity of the device that the requester wishes to establish an STSL connection with. The contents of the TYPE field may indicate that this is a request to establish an STSL connection. TIME OUT may indicate the maximum period of time a device should wait for a response before terminating the STSL connection, once the STSL connection has been established.

CAPABILITY INFO may include information about the capabilities of the requesting device. For two devices to communicate directly with each other, they must share certain capabilities. These capabilities may be of various types, such as but not limited to: 1) supported communications protocols, formats, etc., 2) types of information that may be processed, 3) etc. The SUPPORTED RATE field may be similar, with the source device indicating which data rate(s) it is capable of handling. In some embodiments this may indicate which data rates the device is capable of using in communication, while in other embodiments it may indicate which rates are feasible under current conditions.

FIG. 4B shows the format of a response to the request of FIG. 4A, transmitted by the device that was the recipient of the request. SOURCE ADDR may indicate the identity of the device transmitting this response, while DEST ADDR may indicate the identity of the requesting device. The contents of TYPE may indicate that this is a response to a request to establish an STSL. STATUS may indicate whether the request is being accepted or rejected. In some embodiments, STATUS may also contain other information, such as but not limited to the reason for a rejection. CAPABILITY INFO may indicate the capabilities of the responder. When the requester receives this information, both the requester and the responder will know the capabilities of both devices, and they can each determine which of those capabilities are shared by both devices and can therefore be used in STSL communications. Similarly, when the responder indicates which data rates it supports in the SUPPORTED RATES field, both the requester and responder will know which supported data rates are shared by both devices and can therefore be used in the STSL communications.

FIG. 4C shows the format of an announcement that the STSL is being torn down (terminated), and may be transmitted by either device in the STSL. The SOURCE ADDR identifies the device initiating the termination and transmitting this frame (either STA-A or STA-B of the previous examples), while the DEST ADDR identifies the other device that formed the STSL. TYPE identifies this frame as an STSL Termination frame. Some embodiments may also include a REASON CODE field to identify the reason that the STSL connection is being terminated. In some embodiments, the destination device may be requested to return an acknowledgement frame (not shown), indicating that this termination frame has been received.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
a first wireless communications device to transmit, to an access point, a frame containing data pertaining to a direct station-to-station link (STSL) with a second wireless communications device other than the access point;
wherein data pertaining to the STSL is wholly contained within a payload section of the frame.

2. The apparatus of claim 1, wherein the data is to contain a request to the second wireless communications device for the STSL.

3. The apparatus of claim 2, wherein the data is further to contain information indicating at least one data rate supported by the first wireless communications device.

4. The apparatus of claim 1, wherein the data is to contain a response to a request from the second wireless communications device for the STSL.

5. The apparatus of claim 4, wherein the data is to contain an indication of whether the request is being accepted.

6. The apparatus of claim 1, wherein the data is to contain an indication of terminating the STSL.

7. The apparatus of claim 6, wherein the data is to contain an indication of a reason for terminating the STSL.

8. A method, comprising:
wirelessly transmitting a frame to an access point, the frame having a payload and a destination address different than an address of the access point;
wherein the payload includes data pertaining to a direct station-to-station link (STSL) with a wireless communications device indicated by the destination address.

9. The method of claim 8, wherein the payload comprises a request to establish the STSL with the wireless communications device.

10. The method of claim 9, wherein the payload comprises information about communications capabilities of a device transmitting the frame to the access point.

11. The method of claim 8, wherein the payload comprises a response to a request from the wireless communications device to establish the STSL.

12. The method of claim 11, wherein the payload comprises an indication of whether the request is rejected.

13. The method of claim 9, wherein the payload comprises an indication that the STSL is to be terminated.

14. An article comprising
a tangible machine-readable medium that contains instructions, which when executed by one or more processors result in performing operations comprising:
wirelessly transmitting a frame to an access point, the frame having a payload and a destination address different than an address of the access point;
wherein the payload includes data pertaining to a direct station-to-station link (STSL) with a wireless communications device indicated by the destination address.

15. The article of claim 14, wherein the payload comprises a request to establish the STSL with the wireless communications device.

16. The article of claim 15, wherein the payload comprises information about communications capabilities of a device transmitting the frame to the access point.

17. The article of claim 14, wherein the payload comprises a response to a request from the wireless communications device to establish the STSL.

18. The article of claim 17, wherein the payload comprises an indication of whether the request is rejected.

19. The article of claim 18, wherein the payload further comprises information about communications parameters that can be used in the STSL.

20. The article of claim 14, wherein the payload comprises an indication that the STSL is to be terminated.
